(19) United States
(12) Patent Application Publication
(10) Pub. No.: US 2011/0159878 A1
(43) Pub. Date: Jun. 30, 2011

(54) SYSTEM AND METHOD OF USING A DYNAMIC ACCESS NUMBER ARCHITECTURE

(75) Inventors: Douglas F. Bender, Scotts Valley, CA (US); Raffi Aghapekian, Oakland, CA (US); Kenny Hefner, Austell, GA (US)

(73) Assignee: GEOS COMMUNICATIONS, INC., Southlake, TX (US)

(21) Appl. No.: 12/974,119

(22) Filed: Dec. 21, 2010

Related U.S. Application Data
(60) Provisional application No. 61/290,846, filed on Dec. 29, 2009.

(51) Int. Cl. H04W 40/20; H04W 88/02

(52) U.S. Cl. 455/445; 455/550.1

(57) ABSTRACT

A method of using a dynamic access number architecture of a mobile communication device includes receiving a selection via a user interface of a mobile communication device. The selection indicates a preferred routing number associated with a particular country. The method also includes sending a message from the mobile communication device to a network element to request validation the preferred routing number selection. After a successful validation of the preferred routing number, when the mobile communication device is within the particular country, the mobile communication device automatically routes particular calls via an access device associated with the preferred routing number by dialing the preferred routing number.

### CLAIM OF PRIORITY

This application claims priority from U.S. Provisional Patent Application No. 61/290,846, entitled “SYSTEM AND METHOD OF USING A DYNAMIC ACCESS NUMBER ARCHITECTURE”, filed on Dec. 29, 2009, which is incorporated herein by reference in its entirety.

### FIELD OF THE DISCLOSURE

The present disclosure is generally related to use of a dynamic access network architecture.

### BACKGROUND

Some individuals and businesses find that mobile communications devices provide desirable features, such as the ability to communicate during travel or when away from access to landline communications. Additionally, some calls made via mobile communication devices can be cheaper or more convenient than calls made via a landline telephone. However, some calls made using a mobile communication device can be more expensive than calls made via a landline, such as when a user travels internationally with their mobile communication device.

When a mobile handset user moves between countries and continues to place calls over the mobile handset, the user is usually required to either roam on their host wireless plan (which can be expensive due to the international roaming fees) or swap their host wireless carrier's Subscriber Identity Module (SIM) card for a local SIM card that is available in the country they are traveling in. While the SIM card swapping method may reduce wireless plan fees, the method may add user inconvenience and expense due to purchasing and swapping the local SIM card. Also, the inconvenience is increased if a user travels to multiple countries. As another option, with dual mode phones (phones that support a cellular protocol and an 802.11x protocol), the user may make calls at a local wireless data communication access zone (e.g. a “Hotspot”). However, this option is only available on certain types of phones and at the designated access zone locations.

### BRIEF DESCRIPTION OF THE DRAWINGS

FIG. 1 is a diagram of a first embodiment of a system to make a call;

FIG. 2 is a diagram of a second embodiment of a system to make a call;

FIG. 3 is a flow chart of a first embodiment of a method of making a call;

FIG. 4 is a diagram of a first embodiment of a user interface for making a call;

FIG. 5 is a diagram of a second embodiment of a user interface for making a call;

FIG. 6 is a diagram of a third embodiment of a user interface for making a call;

FIG. 7 is a flow chart of a second embodiment of a method of making a call;

FIG. 8 is a flow chart of a third embodiment of a method of making a call;

FIG. 9 is a flow chart of a fourth embodiment of a method of making a call;

FIG. 10 is a flow chart of an embodiment of a method of using a dynamic access number architecture; and

FIG. 11 is a flow chart of another embodiment of a method of using a dynamic access number architecture.

### DETAILED DESCRIPTION

In a particular embodiment, a method of using a dynamic access number architecture of a mobile communication device is disclosed. The method includes configuration of the mobile communication device (e.g. a mobile phone). The method includes initiating a user interface at the mobile communication device and receiving a selection from a user of at least one country via the user interface. In a particular embodiment, the method may include receiving a list of available routing numbers associated with each country. In a particular illustrative embodiment, the country may be selected by the user via a pull down list of countries. The method further includes receiving a selection of a preferred routing number from a list of available routing numbers with respect to at least one country. For example, each country may be associated with a list of available routing numbers and a user of the mobile communication device may select one of the numbers from the list as a preferred routing number for the country. The preferred routing number may be associated with a particular communication bridge for use in a particular country. The country and the preferred routing number selections may be stored in a memory device, such as a memory within the mobile communication device or within a memory of a server in communication with the mobile communication device. The method further includes sending a message to a network element to request validation of the country and the preferred routing number selections and receiving a validation indicator in response to the message requesting validation.

In response to determining that the validation indicator corresponds to a successful validation, a success message is displayed at the mobile phone to indicate a successful configuration. In response to determining that the validation indicator corresponds to an unsuccessful validation, a failure message is displayed at the mobile communication device. One or more retry attempts may be made after an unsuccessful validation.

After the successful configuration, when a call is placed from the mobile communication device and when the mobile communication device is within the selected country, the call may be redirected to the preferred routing number for the selected country. The call may be redirected to a communication bridge that forwards the call to a destination, such as a destination identified by a phone number input into the mobile communication device.

While the above example refers to a selected country, the mobile communication device may be configured for use with multiple countries. For each country, a preferred routing number may be selected or otherwise assigned (such as a default). Each country may include one or more communication bridges or other types of call routing devices available for use by the wireless network. During travel, a user of the mobile communication device may conveniently avoid roaming charges and may instead have their calls redirected to a communication bridging device based on the particular country and based on their preferences (e.g. based on the preferred routing number). Thus, the user may conveniently travel and avoid roaming fees without replacing SIM cards and without being limited to certain “Hotspot” areas.

In another particular embodiment, a method of validating settings of a mobile communication device is disclosed. The method may be performed at a server or at another computing system having access to a network (e.g. a computer server at a network element). The method includes receiving a message from the mobile communication device, where the message is to request validation of at least one country and preferred routing number selection. The method includes validating the mobile communication device with respect to the at least one country and preferred routing number to determine a validation indicator. A response is sent to the mobile communication device, and the response includes the validation indicator to enable the mobile communication device to redirect calls initiated by the mobile communication device in the selected country to the selected preferred routing number. The method further includes storing the at least one country and the preferred routing number in a memory. Optionally, a server may send a list of available routing numbers to select from to the mobile communication device.

In another particular embodiment, a mobile communication device includes an input device to receive a selection via a user interface. The selection indicates a preferred routing number associated with a particular country. The mobile communication device also includes a signaling module to send a message from the mobile communication device to a network element to request validation of the preferred routing number selection. The mobile communication device also includes a call module to initiate calls from the mobile communication device. After a successful validation of the preferred routing number, when the mobile communication device is within the particular country, the call module automatically routes particular calls via an access device associated with the preferred routing number by dialing the preferred routing number.

In another particular embodiment, a method for use at a mobile communication device is disclosed. The method includes receiving, at the mobile communication device, input indicating a destination address, determining a country in which the mobile communication device is located, initiating a call to a communication bridge via a mobile communication network based on the determined country, and sending an instruction to the communication bridge to initiate a communication connection to the destination address. The mobile communication device may be configured for use with different countries based on the configuration methods described herein. In addition, the mobile communication device may be used in multiple countries and each country may include one or more communication bridge systems.

In another particular embodiment, a mobile communication device is disclosed. The mobile communication device includes an input device to receive input indicating a destination communication address, and a country determination module to determine a country in which the mobile communication device is located. The mobile communication device also includes a call module to initiate a call to a communication bridge selected based on the country and to send an instruction to the communication bridge to initiate a communication connection to the destination communication address. In a particular illustrative implementation, the communication bridge is accessible by a routing number and the routing number is stored at the mobile communication device as a preferred routing number associated with the country.

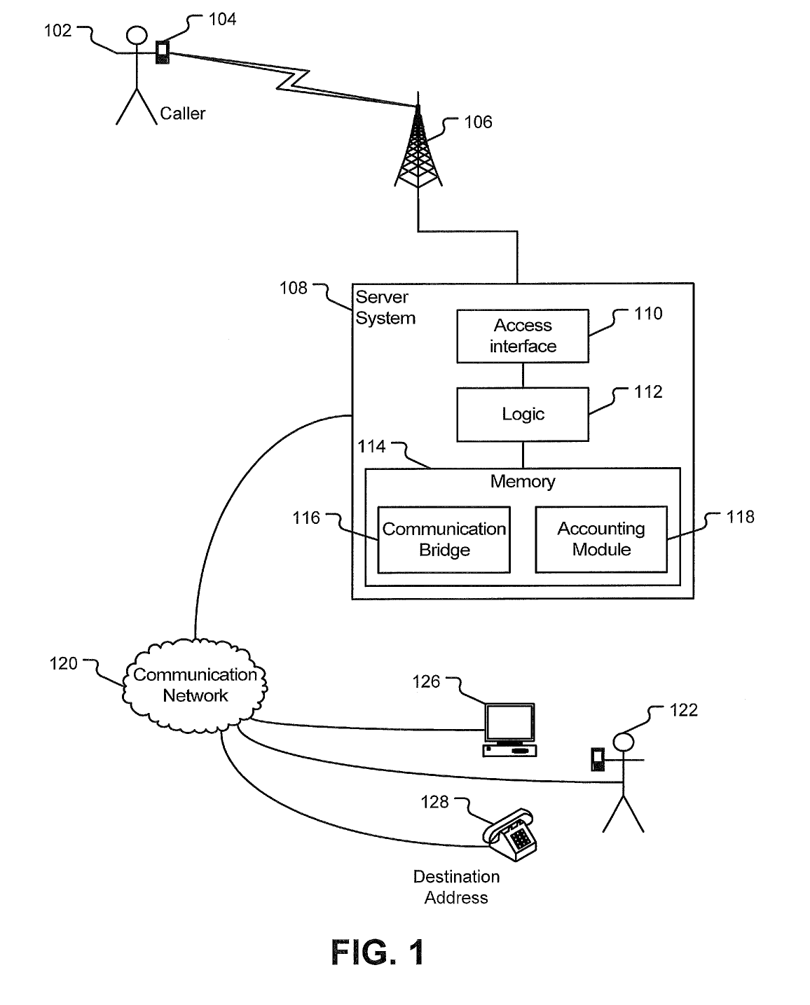

FIG. 1 illustrates a first embodiment of a system to make a call. The system is designated generally 100. The system 100 includes a user 102 having a mobile communication device 104. The mobile communication device 104 is adapted to communicate via a wireless communication system 106. The wireless communication system 106 can communicate with a server system 108. While a single server system 108 is illustrated, the term “system” includes any collection of systems or sub-systems that individually or jointly execute a set, or multiple sets, of instructions to perform one or more of the functions described herein. The server system 108 can bridge communications between the wireless communication system 106 and a communication network 120. The communication network 120 enables Internet Protocol (IP) communication with a second user device, such as computer 126, wireless communication device 124 or wired communication device 128 associated with a second user 122. The communication network 120 can also include one or more additional bridge systems to convert data received from the mobile communication device 104 to another communication protocol, such as IP communication and to transmit the communication over a communication network, such as a Public Switched Telephone Network (PSTN).

The server system 108 includes an access interface 110 to facilitate communication with the wireless communication system 106. The access interface 110 is adapted to receive a call to a communication address associated with the access interface 110. For example, the call can be initiated by the mobile communication device 104 in response to an automatic determination at the mobile communication device 104 to route the call via the access interface 110. To illustrate, the mobile communication device 104 may automatically determine to route a call as a Voice over Internet Protocol (VoIP) call based on an evaluation of a destination address received at the mobile communication device.

The server system 108 also includes logic 112 (e.g., one or more processors) and memory 114 accessible to the logic 112. The memory 114 includes a plurality of modules 116, 118 that are executable by the logic 112 to implement various functions of the server system 108. The modules 116, 118 can be implemented in hardware, software or any combination thereof.

In a particular embodiment, the memory 114 can include a communication bridge 116, such as a VoIP telephony bridge. The VoIP telephony bridge can be executed by the logic 112 to receive a call via the mobile communication system 106 and to communicate with a second device, such as a user device associated with the second user 122, based on the call.

For example, when the communication bridge 116 includes a VoIP telephony bridge, the VoIP telephony bridge is adapted to receive a destination communication address from the module communication device 104, to initiate a call to the destination communication address and to convert voice call data received from the mobile communication device 104 to a VoIP call for transmission to the destination communication address. For example, the VoIP telephony bridge may convert signals received from the mobile communication device 104 in a mobile telephony protocol into VoIP signals for transmission to the destination communication address, and convert VoIP signals received from the destination communication address to mobile telephony protocol signals for transmission to the mobile communication device 104.

In a particular embodiment, the communication bridge 116 may be adapted to facilitate non-voice data communications between the mobile communication device 104 and a device associated with the destination address (e.g., the computer 126, the wireless communication device 124, the wired communication device 128, or another communication device). For example, after the communication bridge 116 has established a communication link between the mobile communication device 104 and a second device (i.e., a device associated with the destination address), the mobile communication device 104 may access data stored at the second device, the second device can send data to the mobile communication device 104, or both. The data can include voice or non-voice data. For example, the data can include multimedia data, text data, graphics data, and so forth. To illustrate a few non-limiting examples, the data can include contact list information, photographs, videos, executable program applications, web pages, or any other type of information.

The memory 114 can also include an accounting module 118. The accounting module 118 can authenticate the mobile communication device 104 based on authentication information received from the mobile communication device 104. For example, the mobile communication device 104 can send authentication information validating that the mobile communication device 104 is authorized to send calls via the server system 108 using the communication bridge 116. In a particular embodiment, a user access telephone number can be associated with a user account record accessible to the accounting module 118. When a call is received at the server system 108 via the user access telephone number, the accounting module 118 can compare caller identification information associated with the call to an authorized telephone record of the user account record. If the caller identification information is associated with an authorized telephone that is related to the user access telephone number, the call is authenticated and the communication bridge 116 is invoked to bridge the call to the destination communication address.

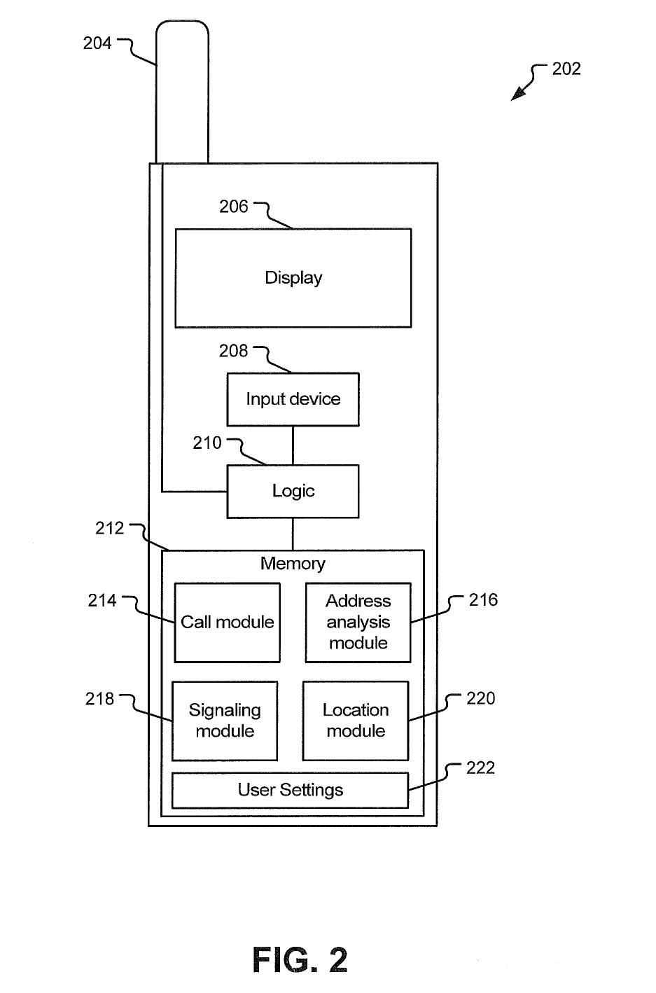

FIG. 2 illustrates a second particular embodiment of a system to make a call. The system includes a mobile communication device 202. The mobile communication device 202 includes an antenna 204 adapted to send and receive wireless communications signals using a wireless communication protocol. The mobile communication device 202 also includes a display 206, and an input device 208. The input device 208 is adapted to receive input indicating a destination communication address, such as a telephone number, a Short Messaging Service (SMS) address, a web site address, etc. The input device 208 can include a microphone, a keypad, a touch screen, one or more soft buttons, other input devices, or any combination thereof.

The mobile communication device 202 also includes logic 210 (such as one or more processors) and memory 212 accessible to the logic 210. In a particular embodiment, the mobile communication device 202 includes a non-transitory computer-readable medium in which one or more sets of instructions, e.g. software, can be embedded. The instructions may embody one or more of the methods or logic as described herein. In a particular embodiment, the instructions may reside completely, or at least partially, within the memory 212, another memory (not shown), and/or within the logic 210. For example, the memory 212 can include one or more modules adapted to implement various functions of the mobile communication device 202. The modules can be implemented in hardware, software, or any combination thereof. For example, the memory 212 can include one or more software applications which, when executed by the logic 210, implement the functions of the one or more modules. In an alternative embodiment, dedicated hardware implementations, such as application specific integrated circuits, programmable logic arrays and other hardware devices, can be constructed to implement one or more of the methods described herein. Accordingly, the system encompasses software, firmware, and hardware implementations.

The mobile communication device 202 also includes an address analysis module 216. The address analysis module 216 is adapted to determine whether a destination communication address received at the mobile communication device 202 is of a predetermined type. In a particular embodiment, the predetermined type of destination address may be determined based on user configuration settings. For example, the user configurations settings may indicate that the predetermined type of destination address includes international telephony addresses, long distance telephony addresses, local telephony addresses, other telephony addresses, an Internet address, a Universal Resource Identifier (URI) address, an electronic messaging address (e.g., an SMS, Multimedia Messaging service (MMS), or email address), or any combination thereof. In a particular embodiment, the address analysis module 216 analyzes alpha-numerical digits of the destination communication address to determine whether the destination communication address is of the predetermined type. In another particular embodiment, the address analysis module 216 compares the destination communication address to one or more destination communication address patterns. The destination communication address patterns can include features that indicate that a call is of a particular type. For example the destination communication address patterns can identify international calls based on the number of digits in the destination communication address. In another example, the destination communication address patterns can identify long-distance calls based on the presence of an area code or the presence of a particular area code in the destination communication address. In still another example, the destination communication address patterns can identify an electronic messaging address or Internet address based on the presence of a URI scheme (e.g., http, mailto, ftp, etc.), or based on other syntax or semantics indicating that the destination communication address is a URI.

The mobile communication device 202 can also include a call module 214. The call module 214 can be adapted to initiate a call to a communication bridge (such as the communication bridge 116 of the server system 108 of FIG. 1) when the destination communication address is of the predetermined type. The call module 214 can also send an instruction to the communication bridge to initiate or route a communication to the destination communication address. In a particular embodiment, the communication bridge includes a Voice over Internet Protocol (VoIP) telephony bridge, and the call module 214 is also adapted to send voice communication data to the VoIP telephony bridge to be converted to VoIP data for communication to the destination address. For example, the call module 214 can communicate with the VoIP telephony bridge using a wireless communication protocol.

The call module 214 can also be adapted to access non-voice data via the communication bridge. For example, the call module 214 may receive non-voice data from a device associated with the destination address after a communication link to the destination address has been established. The call module 214 may be adapted to receive the data, and store the data in the memory 212 for access by another portion of the mobile communication device 202. For example, the call module 214 may receive image data via the communication bridge and store the image data at the memory 212 where the image data can be accessed by an image viewer element (not shown) of the mobile communication device 202. In another example, the call module 214 may receive contact list data via the communication bridge and store the contact list data at the memory 212 where the contact list data can be accessed by an address book manager element (not shown) of the mobile communication device 202.

In a particular embodiment, the mobile communication device 202 may be adapted to operate in conjunction with a Dynamic Access Number Architecture (DANA), as described further below. The DANA may enable the mobile communication device 202 to route calls in a manner that may avoid or reduce international roaming charges. For example, a service provider may provide communication bridges (such as the communication bridge 116 of FIG. 1) in a plurality of different countries. One or more routing numbers may be associated with a communication bridge in a particular country. The mobile communication device 202 may be adapted to communication with a particular communication bridge, using a selected preferred routing number, based on a location of the mobile communication device 202.

For example, the memory 212 of the mobile communication device 202 may include a list of available routing numbers for a particular country. A user may use the input device 208 to designate one or more of the available routing number as a preferred routing number to be associated with a particular country. The preferred routing number may be stored in user settings 222 of the mobile communication device 202. Alternately, or in addition, the preferred routing number may be stored at a network element of a communication network, such as at the server system 108 of FIG. 1. The mobile communication device 202 may include a signaling module 218 that is adapted to send a message from the mobile communication device 202 to a network element to request validation of the preferred routing number selection. For example, the network element may determine whether the preferred routing number has been selected by another user or whether a user account associated with the user is valid and is eligible to use the preferred routing number (e.g., based on a subscription level associated with the account).

The mobile communication device 202 can also include a location module 220. The location module 220 may be adapted to automatically determine a country in which the mobile communication device 202 is located. For example, the location module 220 may include a global positioning satellite system module that determines where the mobile communication device 202 is located using global position satellite signals. In another example, the location module 220 may be adapted to communicate with one or more network elements of a communication network to determine a country in which the mobile communication device 202 is located (e.g., via registration or control messages).

In operation, the mobile communication device 202 may determine that it is located in a particular country using the location module 220. The mobile communication device 202 may determine a list of routing number associated with the particular country, e.g., by accessing the list from the memory 212 or by communicating with a network element of a communication network. The mobile communication device 202 may select a preferred routing number for the particular country. For example, the mobile communication device 202 may automatically select the preferred routing number based on the user settings 222, or the mobile communication device 202 may generate a user interface display via the display 206 and request that the user designate the preferred routing number. The signaling module 218 may validate the preferred routing number by communicating with the communication network.

After the preferred routing number has been validated, the call module 214 may route calls via a communication bridge (e.g., a Voice over Internet Protocol bridge) associated with the preferred routing number while the mobile communication device 202 is located in the country. In a particular embodiment, only certain calls may be routed via the communication bridge associated with the preferred routing number. For example, the address analysis module 216 may analyze a destination address associated with each call and route certain calls via the preferred routing number based on the user settings 222. To illustrate, calls of a predetermined type may be routed via the preferred routing number, and calls that are not of the predetermined type may be routed directly to the destination address (e.g., the call module 214 may directly dial the destination address).

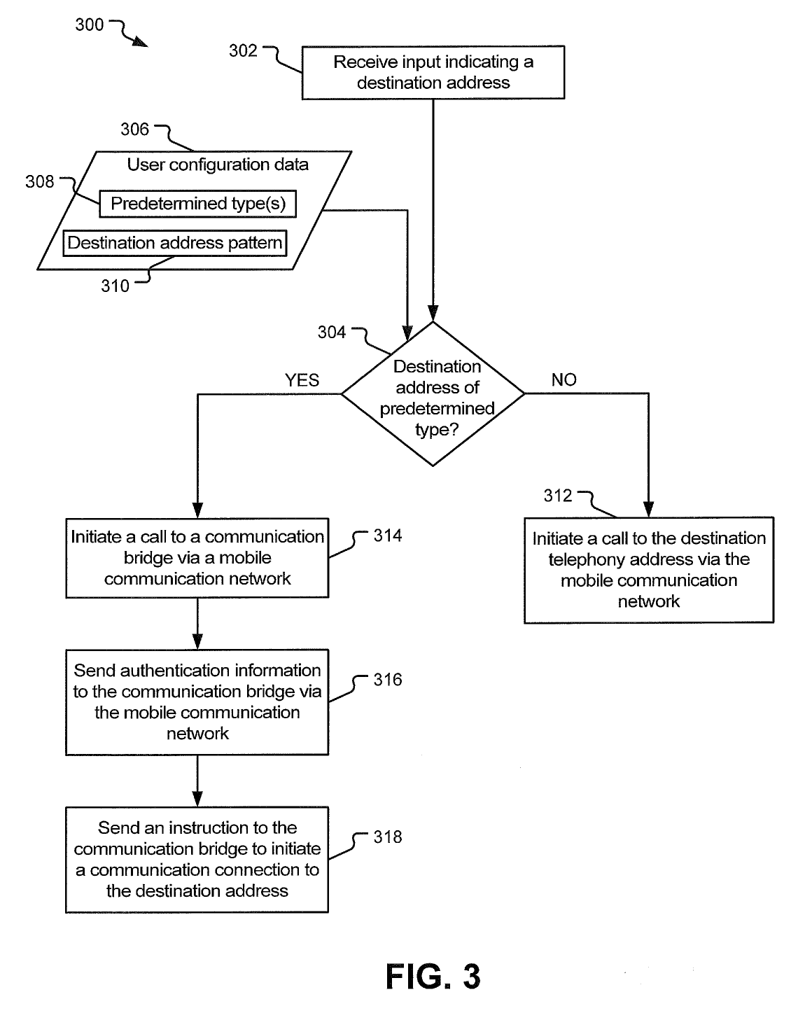

FIG. 3 illustrates a first particular embodiment of a method of making a call. The method is designated generally 300. The method 300 includes, at 302, receiving input indicating a destination communication address at a mobile communication device (such as the mobile communication device 104 of FIG. 1 or the mobile communication device 202 of FIG. 2). For example, the input can include a series of digits entered via a keypad of the mobile communication device, input selecting a communication address from a memory (e.g., from a contact list or speed dial list), a voice input, any other input indicating a destination address, or any combination thereof.

The method 300 also includes, at 304, determining whether the destination communication address is of a predetermined type 308. The method 300 can include accessing user configuration data 306 to determine which types of calls are of the predetermined type(s) 308. The user configuration data 306 can include information defining the predetermined type(s) 308 of destination communication addresses. For example, the predetermined types 308 may include international calls, long-distance calls, local calls, other types of telephony calls, a Universal Resource Identifier (URI), a network address, an electronic messaging address, or any combination thereof. In another particular embodiment, the user configuration data 306 can include one or more destination communication address patterns 310. For example, the destination communication address patterns 310 can include information sufficient to identify a particular type of call, such as an international call or long-distance call. To illustrate, the destination communication address patterns can indicate that calls that include an international calling code are of the predetermined type. In another example, the destination communication address patterns can indicate that calls that include particular area codes are of the predetermined type. Whether the destination communication address of a call is of a predetermined type can also be determined by analyzing alpha-numerical digits of the destination communication address.

When the destination communication address is of the predetermined type, the method 300 includes, at 314, initiating a call to a communication bridge (such as the communication bridge 116 of FIG. 1) via a mobile communication network. For example, the call may be directed to an access number associated with the communication bridge. The method 300 also includes, at 316, sending authentication information to the communication bridge via the mobile communication network. For example, the authentication information can include caller identification information. In another example, the authentication information can include a key or other authentication data stored in a memory of the mobile communication device. The method further includes, at 318, sending an instruction to the communication bridge to initiate a communication connection to the destination communication address. When the communication connection has been established, the communication bridge may convert communication data received from the mobile communication device in a first communication protocol (e.g., a mobile communication protocol) to a second communication protocol for communication to the destination communication address. Similarly, the communication bridge can convert communication data received from the destination communication address in the second protocol to the first protocol for transmission to the mobile communication device.

When the destination communication address is not of the predetermined type, the method 300 includes, at 312, initiating a call to the destination communication address via the mobile communication network. For example, the call can be connected to the destination communication address via a wireless communication network, a Public Switched Telephone Network (PSTN), or both.

In a particular embodiment, the method 300 allows a call to be placed to any destination communication address as a Voice over Internet Protocol (VoIP) call by routing the call through the communication bridge as a VoIP call. The method 300 does not require that a user dial a telephony address of the communication bridge to initiate a call via the communication bridge. Rather, the method 300 determines whether the call is to a particular type of destination address, and automatically calls an access number associated with the communication bridge when the call is to the particular type of destination address. The destination communication address is passed to the communication bridge along with a command to initiate a communication connection to the destination communication address. The method 300 also does not require the user to enter an access code associated with the communication bridge to initiate communication via the communication bridge. Rather, the method 300 can automatically send authentication data from a memory of the mobile communication device to authenticate the mobile communication device to use the communication bridge.

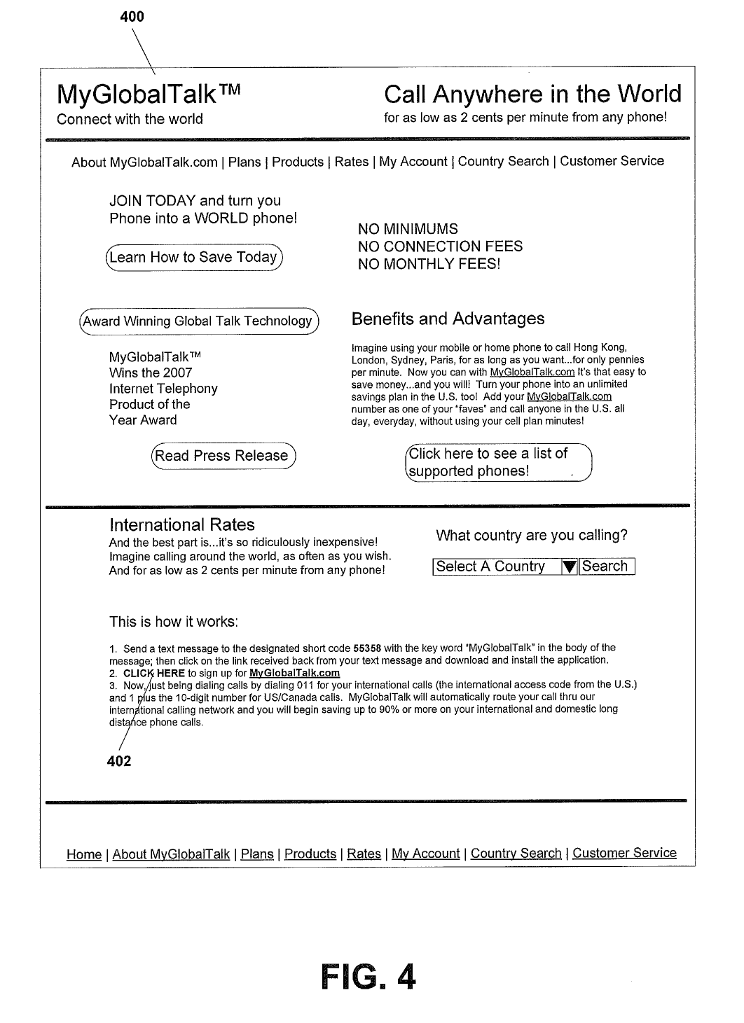

FIG. 4 illustrates a user interface according to a particular embodiment. The user interface is designated generally 400. The user interface 400 includes a user selectable element 402 that allows a user to generate a user account to provide access to a communication bridge, such as the communication bridge 116 of FIG. 1). The user interface 400 also includes information about a service providing access to the communication bridge for making calls.

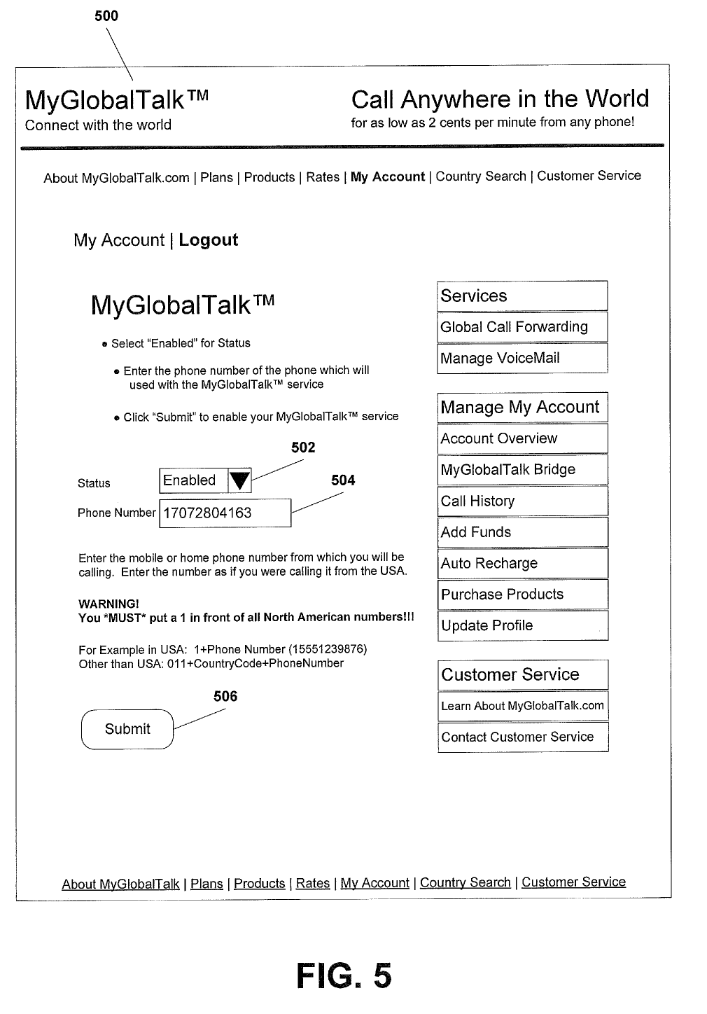

FIG. 5 is a diagram of another user interface according to a particular embodiment. The user interface is designated generally 500. The user interface 500 includes a user input element 504 to allow a user to input a telephone number to be associated with a user account that is authorized to communicate via a communication bridge, such as the communication bridge 116 of FIG. 1. The telephone number provided can be used to authenticate the telephone by comparing the provided telephone number to caller identification information received when the telephone calls the communication bridge. The user interface 500 also includes a user selectable element 502 that allows the user to enable or disable access to the communication bridge. The user interface 500 also includes a user selectable element 506 to save changes that have been made via the user interface 500.

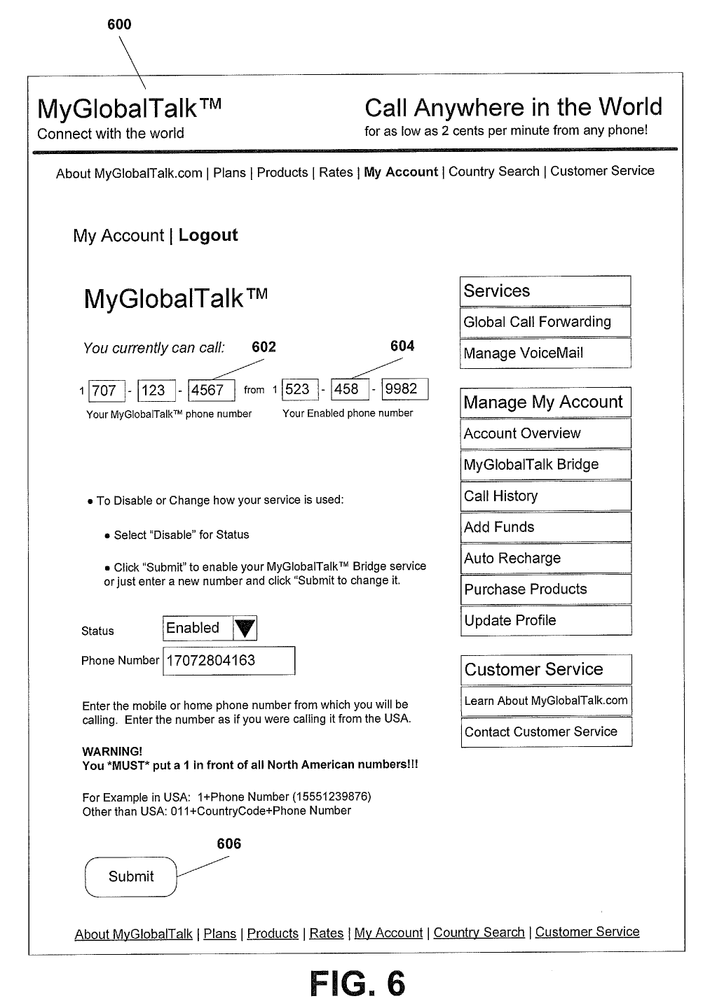

FIG. 6 is a diagram of another user interface according to a particular embodiment. The user interface is designated generally 600. The user interface 600 includes user input element(s) 602 to receive input indicating a user access telephone number associated with a communication bridge, such as the communication bridge 116 of FIG. 1. The user access telephone number is an access number assigned to the user and associated with user's account. A call placed to the user access telephone number is received by the communication bridge or an associated server system, such as the server system 108 of FIG. 1. If the user is authorized to communicate via the communication bridge, the call to the communication bridge can be forwarded to a destination communication address via an appropriate communication protocol. In a particular embodiment, the user account may be associated with a plurality of access numbers. For example, different access numbers may be used for different locations, such that when a call is made from one of the locations an access number is used that causes the call to be a local call.

The user interface 600 also includes user input element(s) 604 to receive a telephone number associated with a telephone authorized to access the communication bridge. The telephone number associated with the authorized telephone can be used by the communication bridge or the associated server system to authenticate that a particular telephone is authorized to communicate via the communication bridge. The telephone number associated with the authorized telephone can also be used by the communication bridge or the associated server system to relate a call to a customer account for billing purposes. The user interface 600 also includes a user selectable element 606 that allows the user to save changes made via the user interface 600. For example, when the user selectable element 606 is selected, changes made via the user interface 600 can be used to update a customer account record.

A particular embodiment is illustrated by the MyGlobalTalk service available from i2 Telecom International, Inc. MyGlobalTalk places Internet telephony in the hands of cell phone users, independent of wireless carrier technology, handset manufacturer, or the type of wireless carrier voice/data plan involved. In addition, MyGlobalTalk is fully functional without local access to the Internet or proximity to an Internet “hotspot”. Users also need not wait for the availability of a dual-mode WiFi phone, because MyGlobalTalk provides the benefits of a dual-mode phone at a fraction of the cost using the customer's existing mobile handset.

MyGlobalTalk is compatible with SmartPhone handsets and with other application enabled handsets, such as Java-enabled handsets, standard landline phones, and other communication devices. The MyGlobalTalk service includes a MyGlobalTalk mobile application and a MyGlobalTalk branded web site, exemplary embodiments of which are illustrated in FIGS. 4-6. The MyGlobalTalk service enables mobile users to access the Internet (e.g., for Internet telephony communications, electronic messaging, or web site access) in an “untethered” manner via their MyGlobalTalk enabled phone.

With MyGlobalTalk, users need not change their traditional dialing procedures—just enter a destination communication address (e.g., dial the destination phone number) and the system automatically utilizes a MyGlobalTalk communication bridge (such as the communication bridge 116 of FIG. 1) when appropriate. For example, cell phone users can use their cell phones for VoIP calling without dialing access codes or making other changes to their normal dialing procedure. Additionally, users can designate when calls should be placed as VoIP calls. This allows the same handset to automatically place some calls as regular telephone calls and some as VoIP calls based on user specified settings.

To initially access the MyGlobalTalk service, a user may send a message, such as an SMS message, using a designated Common Short Code with an associated keyword. The user then receives a message that includes a link for downloading the MyGlobalTalk mobile application or widget to his or her mobile communication device. The user can select the link to download the application. Once the application has been downloaded, the user may launch the application for subsequent installation and setup. When prompted by an install script, the user may enter a phone number that was selected at the time the user signed up for the MyGlobalTalk service (e.g., a user access telephone number). Also during the installation and setup, the user can “ENABLE” the application. (It is worth noting that analysis, to date, indicates that only minimal battery drain is experienced while the MyGlobalTalk application is ENABLED). Once these steps are complete, the user is finished with the setup phase, and the user can begin using the MyGlobalTalk service.

Users can seamlessly dial international long distance calls without needing to enter any extra digits—just dial as one would normally dial an international number on a land-line phone. Other options can be available to the user as well, such as:

1) Selectively using MyGlobalTalk for:
i. International calling
ii. Domestic calling
iii. Domestic long-distance calling
iv. International & Domestic calling
v. All Calling
vi. Internet browsing and access
vii. Electronic messaging
viii. Other communications or combinations of the above;

2) MyGlobalTalk presence to detect a user's availability via the service;

3) MyGlobalTalk buddy lists;

4) MyGlobalTalk friends and family for account sharing;

5) MyGlobalTalk Party Line for conference calling;

6) MyGlobalTalk hide-n-seek for in-bound communications parsing or screening;

7) MyGlobalTalk neighborhood dialing for no cost communications when dialing from one MyGlobalTalk number to another MyGlobalTalk number;

8) MyGlobalTalk speed dials to input particular predefined communication address with a single click;

9) MyGlobalTalk v-bridge to direct dial VoIP users associated with other VoIP service providers, e.g., Skype, or GoogleTalk; and

10) MyGlobalTalk Real-Time for real-time or prompt feedback to user regarding the cost of a communication in progress or just completed

One feature of the MyGlobalTalk service relates to how the service takes advantage of the particular services offered by certain wireless carriers. While the MyGlobalTalk service offers customers significant cost savings and is very easy to use, there are a number of carriers with certain branded features that, when coupled with the MyGlobalTalk service, can substantially reduce the cost of these cellular plans. For example, many wireless carriers allow free calls to be made to certain preselected telephone numbers. Examples includes T-Mobile's “myFaves” service, Sprint's “Sprint-to-Home” service, AllTel's “myCircle” service, and so forth.

A user may designate his or her MyGlobalTalk phone number (e.g., a user access number associated with the user's account) as a preselected free calling number, e.g., a “home” or “favorite” number. To illustrate, with T-Mobile's myFaves service users can designate up to five (5) “favorite” numbers, with Sprint's Sprint-to-Home service users can designate a single number, or with AllTel's myCircle service users can designate up to ten (10) numbers. In each case, if a MyGlobalTalk user designates his or her MyGlobalTalk phone number as one of the designated numbers, then when the MyGlobalTalk application is enabled and a call is automatically routed to the MyGlobalTalk communication bridge, the call does not subtract minutes from the cell phone calling plan. The savings for business travelers, students, military users, ex-patriates, and other users that frequently make international calls, can be very substantial. With the MyGlobalTalk service, these users can complete these calls from their mobile handsets without being charged per minute fees or using an allocation of free or prepaid minutes. By enabling the MyGlobalTalk service for all international calls plus domestic calls, or selecting the “All Calls” option of the MyGlobalTalk service, all of the user's calls can be completed without ever touching the user's cellular calling plan minutes. This may enable users to sign up for the minimum-cost plans offered by wireless carriers and yet still be able to make an unlimited number of international and domestic long-distance calls.

The MyGlobalTalk service and application are simple to use and, once activated, do not require further adjustments. The Download and Setup process utilizes standard SMS text messaging for acquiring the MyGlobalTalk application and two simple data entry points during installation and setup.

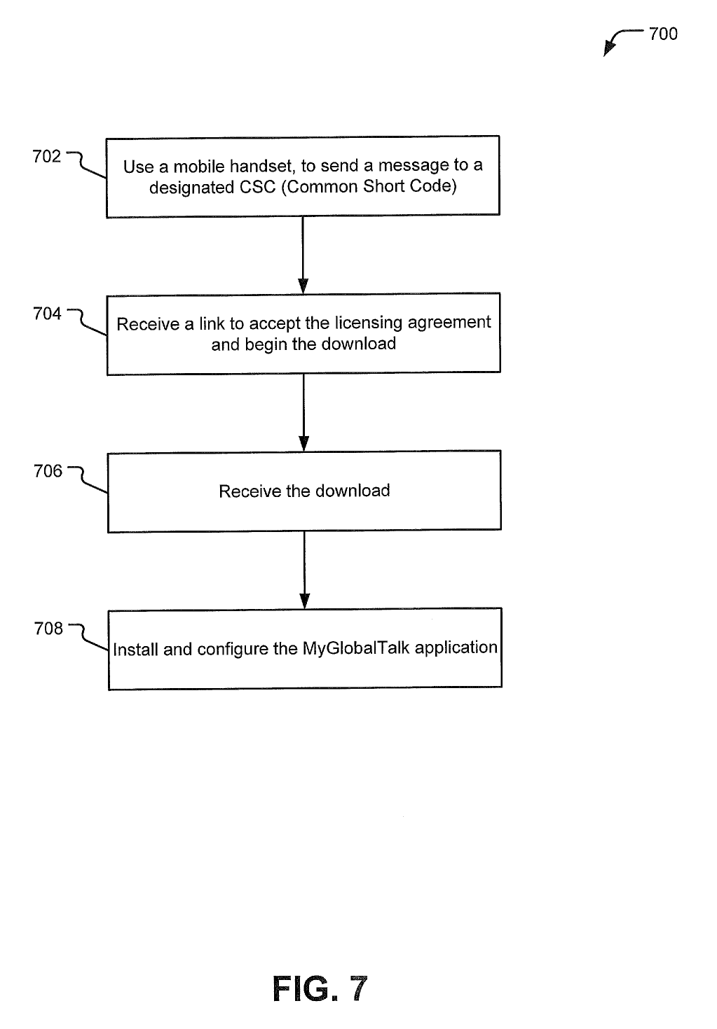

FIG. 7 illustrates a particular embodiment of a method of downloading an application to enable a communication device to automatically route telephone calls via a communication bridge (such as the communication bridge 116 of FIG. 1). For example, the application may include the MyGlobalTalk application. The method is designated generally 700.

The method 700 includes, at 702, using a communication device, such as a mobile handset, to send a message to a communication address, such as a designated CSC (Common Short Code). For example, the message may include the keyword associated with the application. To illustrate, the message may include “MyGlobalTalk” in the subject line or body of the message. A server system (such as a MyGlobalTalk service system) may send a response to the mobile handset. The response can include a link that, when activated, connects the mobile handset to a download server. The method 700 also includes, at 704, receiving the link and selecting the link to accept a licensing agreement and begin download of the application. The method 700 also includes, at 706, receiving the download. For example, the download can include a MyGlobalTalk application or an installation application or script that installs the MyGlobalTalk application. The method 700 further includes, at 708, installing and configuring the MyGlobalTalk application on the mobile handset.

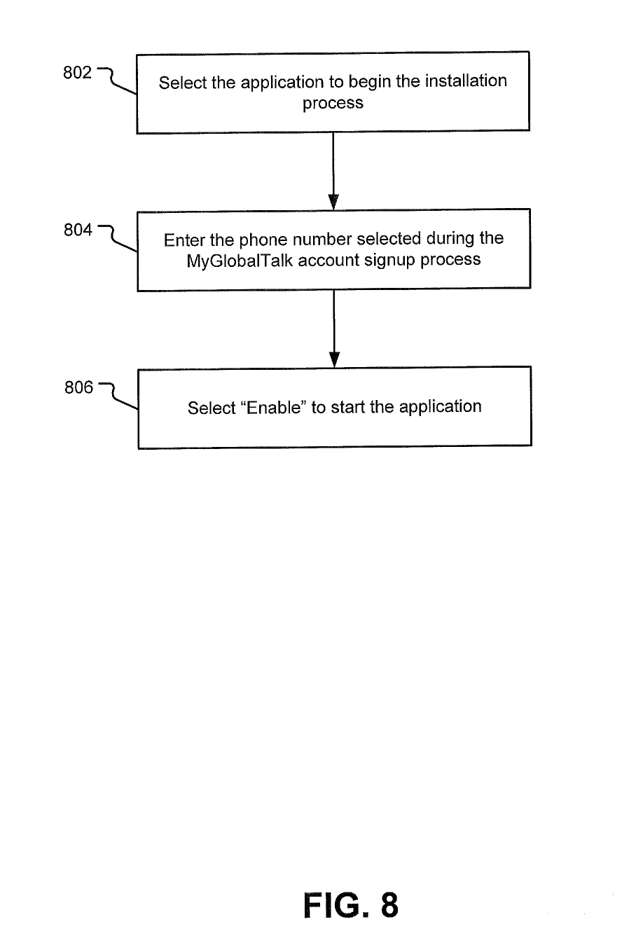

FIG. 8 illustrates a particular embodiment of a method of downloading an application to automatically route calls to a communication bridge, such as the communication bridge 116 of FIG. 1. For example, the application may include a MyGlobalTalk application. The method is designated generally 800.

The method 800 includes, at 802, selecting an installation application to begin the installation. For example, the user may find the installation application in a memory of a mobile handset and click (or double-click) on the installation application to begin the installation process. The method 800 may also include, at 804, entering an access telephone number into the mobile handset. For example, the access number may be a phone number that was selected during signup or set up of a MyGlobalTalk account. The access telephone number may be associated with the mobile handset and/or a user account. The method 800 also includes, at 806, selecting to enable the MyGlobalTalk application.

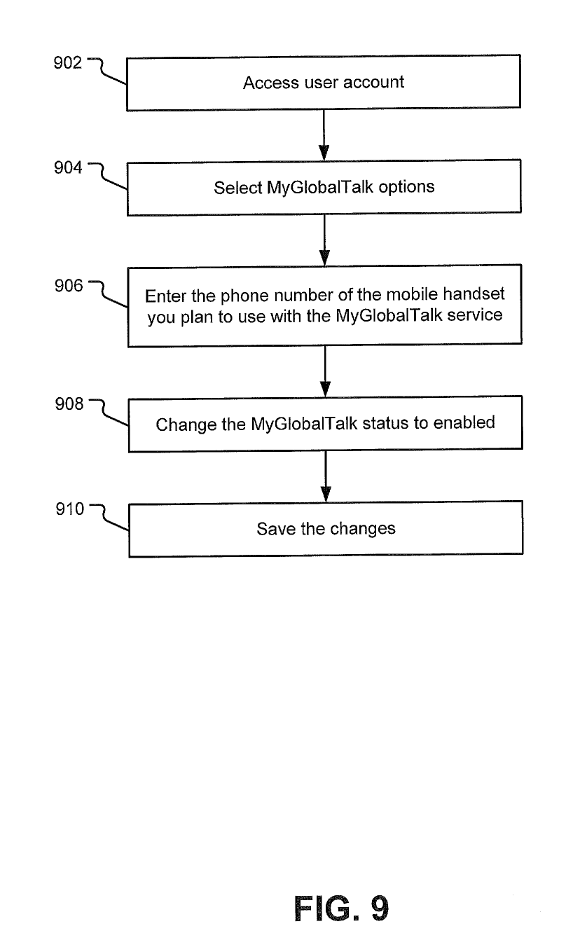

FIG. 9 illustrates a particular embodiment of a method of setting up a user account to access a communication bridge, such as the communication bridge 116 of FIG. 1. For example, the user account may be a MyGlobalTalk account. The method is designated generally 900.

The method 900 includes, at 902, accessing a user account associated with a communication service, such as the MyGlobalTalk service. For example, the user may log into an online account using access credentials, such as a User Name and Password associated with the user's MyGlobalTalk service account. The method 900 also includes, at 904, selecting account options. The method 900 also includes, at 906, entering a communication address (e.g., a phone number) associated with a mobile handset (or other communication device) that the user plans to use with the communication service. The method 900 further includes, at 908, changing the communication status to enabled. The method 900 also includes, at 910, saving the changes to the user account. For example, the user may select a “submit” option. After the account set up process is complete, the communication service may be ready for use.

To use the communication service (such as the MyGlobalTalk service), the user may input a destination communication address (e.g., by dialing a telephone number as normal). An application running on the user's mobile handset, such as the MyGlobalTalk application, may determine proper call routing based on the set-up options. In addition, the communication service may permit multiple methods of receiving the destination communication address, including: 1) Keypad, 2) Contacts, and 3) Call History. In each case, the application may analyze the destination communication address and may route the call according to the user's set up parameters. The application may also remember its users, and whenever an update, a new feature, or a newer version of the application becomes available, the users may receive a notification on their handset with instructions on how to acquire the updates. The application and updates may be available to the users, regardless of which mobile communication service provider they use.

In a particular embodiment, additional ease of use and flexibility may be provided to the systems and methods of routing calls described with reference to FIGS. 1-9 by using dynamic access number assignment. An exemplary dynamic access number assignment system, International Roaming Using Dynamic Access Number Architecture (DANA), is described herein. The DANA enables selection of a local routing number for use in a particular country to enable routing of calls in the particular country without incurring international roaming fees.

Using DANA, calls may be routed at low calling rates (e.g., without roaming fees). DANA may also enable users to roam internationally with the same or similar reduced-rate calling capability. An application supporting DANA may be stored on a user's mobile handset allowing the user the freedom to roam in any country supported by the appropriate communication architecture. For example, the MyGlobalTalk service described above may provide support in about 63 countries. A “server side” component may be used to provide authentication and a listing of available access numbers that can be downloaded/refreshed by the user's mobile handset.

With the DANA application onboard on the user's handset, the user may travel from country to country and may place reduced-charge calls. For example, the user can access settings on the handset and make a selection from a list of countries which are available for roaming. The user's selection may then be authenticated through an interaction between the user's handset and the service provider's network (e.g., the server side component) supporting the underlying telephony services.

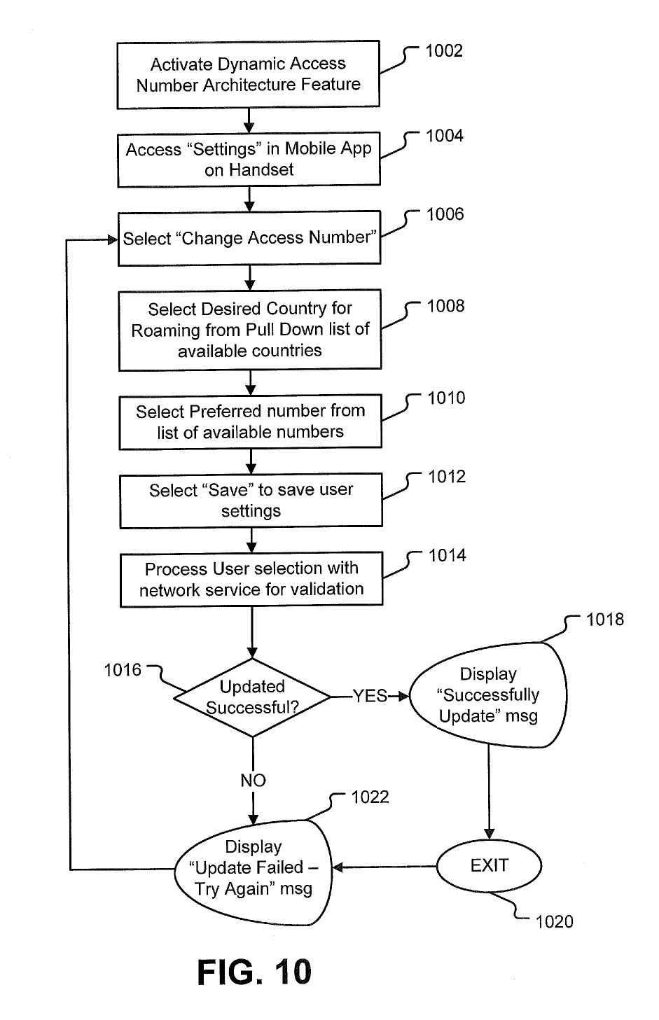

FIG. 10 is a flow chart of a particular embodiment a method of configuring a mobile communication device. A Dynamic Access Number Architecture (DANA) feature is activated, at 1002. For example, the DANA application included in the memory 212 of FIG. 2 may be activated. To illustrate, the DANA application may be implemented as part of the address analysis module 216, the call module 214, the signaling module 218, the location module 220, another module or set of instructions stored in the memory 212 and executable by the logic 210, or any combination thereof. The DANA feature may be implemented via dedicated circuitry, firmware, computer executable instructions executed by a hardware processor or processing unit, or a combination thereof. For example, the DANA feature may be implemented via the logic 210 of FIG. 2.

A “Settings” option may be selected, at 1004. For example, the mobile communication device may initiate presentation of a user interface that includes a menu at a display, such as the display 206 of the mobile communication device 202 of FIG. 2. The user interface may include a menu of a selectable menu option that enables the user to initiate a configuration settings update of the mobile application. Alternatively, or in addition, a user selection may be made at the user interface such as via a selection of a configuration icon at a touchscreen display, via a speech recognition process, or via one or more other mechanisms to receive user input at the mobile communication device.

A “Change Access Number” option may be selected, at 1006. For example, in response to receiving the “Settings” selection, the mobile communication device may initiate presentation of a selectable menu option that enables the user to initiate a process to change an access number.

One or more desired countries for roaming may be selected, at 1008. For example, a desired country for roaming may be selected via a user interface that includes a pull-down list of available countries. The mobile communication device may receive the selection of countries via the user interface.

One or more preferred access numbers (or routing numbers) may be selected, at 1010. For example, a preferred access number may be selected via a user interface from a list of access numbers available for the one or more desired countries. The mobile communication device may populate the list in response to a selection of one or more countries. In a particular embodiment, the list of available access numbers, the list of available countries, or both, is stored at the mobile communication device. In another particular embodiment, the list of available access numbers, the list of available countries, or both, is received from a network element, such as the server system 108 of FIG. 1. The mobile communication device may receive the selection of the one or more preferred access numbers via the user interface.

In a particular embodiment, a list of available access numbers for a particular country may be sent to the mobile communication device in response to determining that the mobile communication device is in the particular country. For example, a user may travel with the mobile communication device. When the user arrives in a new country, the mobile communication device may detect that it is located in the new country. For example, the mobile communication device may interact with one or more network elements of a communication network in the new country using control signals. To illustrate, control signals that are used to register the mobile communication device with the communication network in the new country may be used to determine that the mobile communication device is in the new country. The mobile communication device may notify the user that the mobile communication device is in the new country and may ask the user whether the user would like to selected a preferred routing number associated with the new country (e.g., via a user interface display). When the user indicates a desire to select a new preferred routing number, the mobile communication device may access determine routing numbers associated with the new country. For example, the mobile communication device may store a list of routing numbers in a memory of the mobile communication device (e.g., the memory 212 of FIG. 2). In another example, the mobile communication device may send a query via the communication network to identify the list of routing number for the new country.

User settings may be saved at the mobile communication device, at 1012. For example, a “Save” option may be selected via a user interface to save settings entered by the user, such as the one or more selected countries, the one or more preferred access numbers, or a combination thereof.

The user selection(s) may be processed with a network service for validation, at 1014. For example, the mobile communication device may generate a message to be provided to a network element, such as the server system 108 of FIG. 1, indicating the one or more selected countries, the one or more selected numbers, or both, to be associated with the mobile communication device. The received user selection(s) may be processed and a response returned from the network element to the mobile communication device indicating whether validation was successful or unsuccessful.

In response to determining that the update was successful (e.g. when the response from the network element indicates successful validation), at 1016, the mobile communication device may display a success message, such as “Successfully Updated” message, at 1018, and a configuration process may end, at 1020.

Otherwise, in response to determining that the update was not successful, (e.g. the response from the network element indicates unsuccessful validation), at 1016, the mobile communication device may display a failure message, such as “Update Failed—Try Again,” at 1022. After the unsuccessful validation, processing may return to a user setting or configuration menu to enable the user to select the “Change Access Number,” at 1006.

Thus, the method includes configuration of the mobile communication device (e.g. a mobile phone). The method may include initiating a user interface at the mobile communication device and receiving a selection from a user of at least one country via the user interface. In a particular embodiment, the method may include receiving a list of available routing numbers associated with each country.

The method may further include receiving a selection of a preferred routing number from a list of available routing numbers (e.g. by a user selecting a preferred access number, at 1010) with respect to at least one country. For example, each country may be associated with a list of available routing numbers and a user of the mobile communication device may select one of the numbers from the list as a preferred routing number for the country. In another example, the list of preferred routing numbers for a particular country may be sent to the mobile communication device when the mobile communication device is determined to be located in the particular country. The preferred routing number may be associated with a particular communication bridge for use in a particular country, such as the communication bridge 116 of FIG. 1. The country and the preferred routing number selections may be stored in a memory device, such as a memory within the mobile communication device (e.g. the memory 212 of FIG. 2) or within a memory of a server in communication with the mobile communication device (e.g. the memory 114 of FIG. 1). The method may further include sending a message to a network element to request validation of the country and the preferred routing number selections and receiving a validation indicator in response to the validation request.

The message from the mobile communication device to request validation of at least one country and/or preferred routing number selection may be received at a computer server at a network element, such as the server system 108 of FIG. 1, that validates the mobile communication device with respect to the at least one country and preferred routing number to determine the validation indicator. The computer server may store the at least one country and the preferred routing number in a memory, such as the memory 114 of FIG. 1.

After the successful configuration, when a call is placed from the mobile communication device and when the mobile communication device is within the selected country, the call may be redirected to the preferred routing number for the selected country. The call may be redirected to a communication bridge or other access device that forwards the call to a destination, such as a destination identified by a phone number input into the mobile communication device.

To illustrate, a destination address may be received at a mobile communication device such as via the input device 208 of FIG. 2. The mobile communication device may also receive input determining a country in which the mobile communication device is located. For example, a user may indicate which country the mobile communication device 202 of FIG. 2 is located in via the input device 208. In another example, control signaling between the mobile communication device and a communication network may be used to determine in which country the mobile communication device is located. The mobile communication device may initiate a call to a communication bridge, such as the communication bridge 116 of FIG. 1, via a mobile communication network based on the determined country, and may send an instruction to the communication bridge to initiate a communication connection to the destination address. The mobile communication device may be configured for use with different countries based on the configuration methods described herein. In addition, the mobile communication device may be used in multiple countries and each country may include one or more communication bridge systems. In a particular embodiment, when the mobile communication device returns to a home country, the mobile communication device may automatically reset user preferences to route calls according to preferences associated with the home country. For example, certain calls (e.g., local calls) may not be routed through a Voice over Internet Protocol (VoIP) bridge while in the home country. The mobile communication device may prompt the user for approval before resetting the user preferences to route calls according to preferences associated with the home country.

While the above example refers to a selected country, the mobile communication device may be configured for use with multiple countries. For each country, a preferred routing number may be selected or otherwise assigned (such as a default). Each country may include one or more communication bridges or other types of call routing devices available for use by the wireless network. Upon traveling, a user of the mobile communication device may conveniently avoid roaming charges and may instead have their calls redirected to a routing device based on the particular country and based on their preferences (e.g. based on the preferred routing number). In particular embodiments, the mobile communication device may automatically determine a country in which the mobile communication device is located and may prompt the user to select a preferred routing number associated with the country or automatically select a preferred routing number associated with the country from a list of available routing numbers based on user preference settings. Thus, the user may conveniently travel and avoid roaming fees without replacing SIM cards and without being limited to certain “Hotspot” areas. Additionally, when the user returns to a home country, settings of the mobile communication device may be reset to home country user preference settings. For example, the mobile communication device may automatically reset the user preference settings, or the mobile communication device may prompt the user to reset the user preference settings.

In another particular embodiment, a mobile communication device is disclosed. The mobile communication device includes an input device to receive input indicating a destination communication address, and a country determination module to determine a country in which the mobile communication device is located. The mobile communication device also includes a call module to initiate a call to a communication bridge selected based on the country and to send an instruction to the communication bridge to initiate a communication connection to the destination communication address. In a particular illustrative implementation, the communication bridge is accessible by a routing number and the routing number is stored at the mobile communication device as a preferred routing number associated with the country.

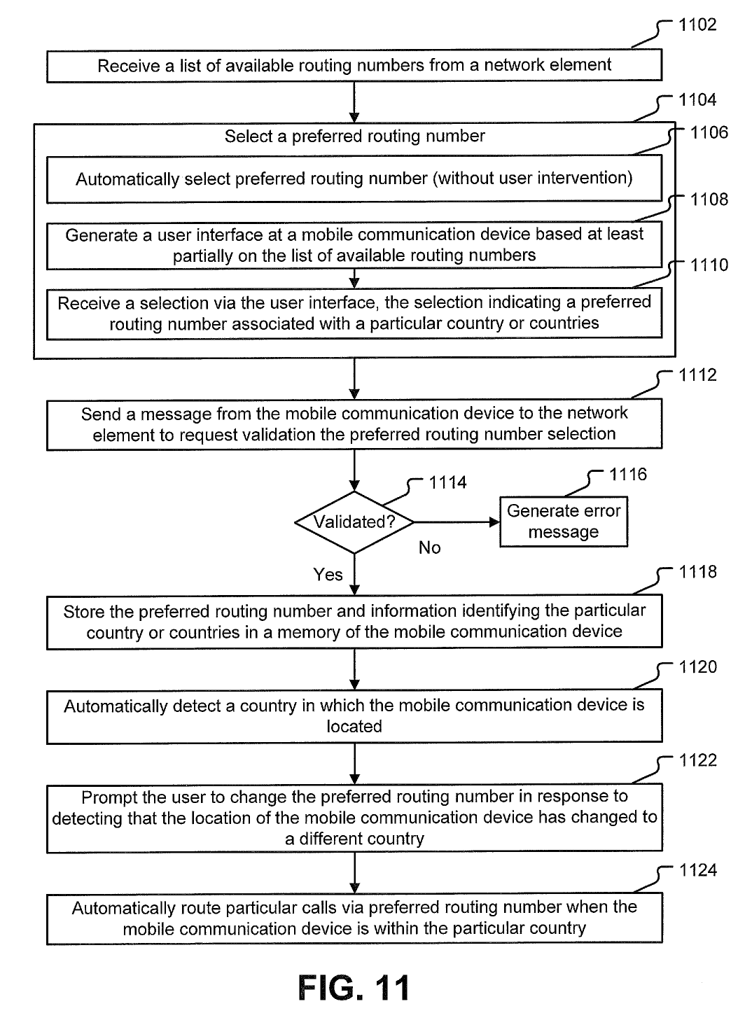

FIG. 11 is a flow chart of another embodiment of a method of using a dynamic access number architecture. In the method of FIG. 11, a list of available routing numbers may be received at a mobile communication device (such as the mobile communication device 202 of FIG. 2) from a network element (such as the server system 108 of FIG. 1), at 1102. For example, the mobile communication device may automatically determine that it has entered an area associated with one or more new routing numbers (i.e., routing numbers that are not currently selected for use by the mobile communication device) and may query the network element to provide the list of available routing numbers. In another example, the network element may automatically detect that the mobile communication device has entered the area associated with the new routing numbers and may send (e.g., “push”) the list of available routing numbers to the mobile communication device.

A preferred routing number may be selected from the list of available routing numbers, at 1104. In a particular embodiment, the mobile communication device automatically (e.g., without user intervention) selects a routing number for use from the list of available routing numbers, at 1106. In this embodiment, the routing number and information identifying the country may be stored in a memory of the mobile communication device, at 1118, in response to the routing number being automatically selected or in response to the selected routing number being validated. In another particular embodiment, the list of available routing numbers is provided to a user to select a routing number for use. For example, a user interface may be generated at the mobile communication device based at least partially on the list of available routing numbers, at 1108. A selection may be received via the user interface, at 1110. The selection may indicate a preferred routing number associated with a particular country. The mobile communication device may send a message to the network element to request validation the preferred routing number selection, at 1112.

When the preferred routing number is not validated by the network element, at 1114, an error message may be generated at a display of the mobile communication device, at 1116. When the preferred routing number is validated, at 1114, the preferred routing number and information identifying the particular country may be store in a memory of the mobile communication device, at 1118.

The mobile communication device may automatically detect a country in which the mobile communication device is located, at 1120. In response to detecting that the location of the mobile communication device has changed to a different country, the user may be prompted to change the preferred routing number, at 1122. For example, the mobile communication device may generate a user interface display prompting the user to select a new preferred routing number that is associated with the new country. Alternately, the mobile communication device may prompt the user to change to a previously configured preferred routing number for the new country. For example, the previously configured preferred routing number for the new country may be stored in a memory of the mobile communication device.

Thus, the mobile communication device may use different routing numbers to route calls in different countries. To illustrate, the mobile communication device may store first user setting associated with a first country and second user setting associated with a second country (different from the first country) in a memory of the mobile communication device. In response to determining that the mobile communication device is located in the first country, calls may be routed according the first user settings. In response to determining that the mobile communication device is located in the second country, calls may be routed according the second user settings. Thus, for example, when the user returns to a home country, home country users settings may be automatically restored or the user may be prompted to restore the home country user settings.

The mobile communication device may automatically route particular calls via an access device associated with the preferred routing number by dialing the preferred routing number when the mobile communication device is within the particular country, at 1124. For example, when input specifying a destination address (different than the preferred routing number) of a call is received at the mobile communication device from the user, the mobile communication device may determine whether the destination address is of a predetermined type. When the destination address is not of the predetermined type, the call may be not routed via the access device. For example, the mobile communication device may directly dial the destination address. When the destination address is of the predetermined type, the call may be routed via the access device using the preferred routing number. In a particular embodiment, the mobile communication device determines whether the destination address is of the predetermined type by accessing user settings in a memory of the mobile communication device. The user settings may include information specifying the predetermined type. In another particular embodiment, the mobile communication device determines whether the destination address is of the predetermined type by comparing the destination address to a destination communication address pattern.

The present disclosure contemplates a computer-readable medium that includes instructions, so that a device connected to a network can communicate voice, video or data over the network. The term “computer-readable medium” includes a single medium or multiple media, such as a centralized or distributed database, and/or associated caches and servers that store one or more sets of instructions. The term “computer-readable medium” includes any non-transitory medium that is capable of storing, encoding or otherwise tangibly embodying a set of instructions for execution by a processor or that cause a computer system to perform any one or more of the methods or operations disclosed herein.

In a particular non-limiting, exemplary embodiment, the computer-readable medium can include a solid-state memory such as a memory card, a Subscriber Identity Module (SIM) card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device. Accordingly, the disclosure is considered to include any one or more of a computer-readable medium in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
receiving a selection via a user interface of a mobile communication device, the selection indicating a preferred routing number associated with a particular country; and
sending a message from the mobile communication device to a network element to request validation the preferred routing number selection;
wherein, after a successful validation of the preferred routing number, when the mobile communication device is within the particular country, the mobile communication device automatically routes particular calls via an access device associated with the preferred routing number by dialing the preferred routing number.

2. The method of claim 1, further comprising:
receiving input specifying a destination address of a call at the mobile communication device, wherein the destination address is different than the preferred routing number; and
determining, at the mobile communication device, whether the destination address is of a predetermined type,
wherein, when the destination address is not of the predetermined type, the call is not routed via the access device.

3. The method of claim 2, wherein, when the destination address is of the predetermined type, the call is routed via the access device.

4. The method of claim 2, wherein determining whether the destination address is of the predetermined type comprises accessing user settings in a memory of the mobile communication device, wherein the user settings include information specifying the predetermined type.

5. The method of claim 2, wherein determining whether the destination address is of the predetermined type comprises comparing the destination address to a destination communication address pattern at the mobile communication device.

6. The method of claim 1, further comprising storing the preferred routing number and information identifying the particular country in a memory of the mobile communication device.

7. The method of claim 1, further comprising receiving a list of available routing numbers from the network element before receiving the selection indicating the preferred routing number.

8. The method of claim 7, further comprising generating the user interface at the mobile communication device based at least partially on the list of available routing numbers.

9. The method of claim 8, wherein the user interface is generated further based on a country in which the mobile communication device is located when the user interface is generated.

10. The method of claim 1, further comprising automatically detecting, at the mobile communication device, a country in which the mobile communication device is located.

11. The method of claim 1, further comprising:
storing first user setting associated with the particular country and second user setting associated with a second country in a memory of the mobile communication device, wherein the second country is different from the particular country; and
in response to determining that the mobile communication device is located in the second country, routing calls from the mobile communication device according the second user settings.

12. The method of claim 1, further comprising, in response to detecting that the mobile communication device has moved to a different country, prompting the user to change the preferred routing number.

13. A mobile communication device comprising:
an input device to receive a selection via a user interface of a mobile communication device, the selection indicating a preferred routing number associated with a particular country;
a signaling module to send a message from the mobile communication device to a network element to request validation the preferred routing number selection; and
a call module to initiate calls from the mobile communication device, wherein, after a successful validation of the preferred routing number, when the mobile communication device is within the particular country, the call module automatically routes particular calls via an access device associated with the preferred routing number by dialing the preferred routing number.

14. The mobile communication device of claim 13, further comprising an address analysis module to determine whether a destination communication address to be called is of a predetermined type, wherein the call module automatically dials the preferred routing number when the destination communication address is of the predetermined type.

15. The mobile communication device of claim 14, wherein the call module sends information indicating the destination communication address to a network device at the preferred routing number after dialing the preferred routing number.

16. The mobile communication device of claim 14, wherein the call module dials the destination communication address when the destination communication address is not of the predetermined type.

17. The mobile communication device of claim 13, further comprising a location module operable to determine a country in which the mobile communication device is located.

18. A non-transitory computer-readable medium comprising instructions executable by a processor to cause the processor to:
receive a selection via a user interface of a mobile communication device, the selection indicating a preferred routing number associated with a particular country; and
send a message from the mobile communication device to a network element to request validation of the preferred routing number selection;
wherein, after a successful validation of the preferred routing number, when the mobile communication device is within the particular country, the mobile communication device automatically routes particular calls via an access device associated with the preferred routing number by dialing the preferred routing number.

19. The non-transitory computer-readable medium of claim 18, wherein the instructions are further executable by the processor to cause the processor to:
communicate with a network to automatically identify a country in which the mobile communication device is located; and
generated a user interface at the mobile communication device, wherein the user interface prompts the user to use the preferred routing number associated with the country.

20. The non-transitory computer-readable medium of claim 18, wherein the instructions are further executable by the processor to cause the processor to:
receive a list of available routing numbers from the network element before receiving the selection indicating the preferred routing number; and
generate a user interface prompting the user to select the preferred routing number at the mobile communication device, the user interface based on the list of available routing numbers and based on a country in which the mobile communication device is located when the user interface is generated.
